(19) United States
(12) Patent Application Publication
(10) Pub. No.: US 2010/0142028 A1
(43) Pub. Date: Jun. 10, 2010

(54) Magneto-Optic Optical Modulator

(75) Inventors: Alexander Umnov, Sachse, TX (US); Takao Naito, Plano, TX (US)

Correspondence Address: BAKER BOTTS L.L.P., 2001 ROSS AVENUE, SUITE 600, DALLAS, TX, 75201-2980, US

(73) Assignee: Fujitsu Limited, Kanagawa (JP)

(21) Appl. No.: 12/632,531

(22) Filed: Dec. 7, 2009

Related U.S. Application Data
(60) Provisional application No. 61/121,389, filed on Dec. 10, 2008.

(51) Int. Cl. G02F 1/09; H04B 10/20

(52) U.S. Cl. 359/282; 398/58

(57) ABSTRACT

In accordance with a particular embodiment of the present invention, a device for modulating an optical beam is provided. The device may include a substrate comprising a non-ferromagnetic material and a thin film comprising a ferromagnetic semiconductor material disposed on the substrate. The thin film may be disposed on the substrate such that at least part of an optical beam incident on the thin film at an angle reflects off of a surface of the thin film. The thin film may be responsive to a magnetic field applied to the thin film such that varying the magnetic field varies the polarization of the light beam reflected off of the surface of the thin film.

### CROSS-REFERENCE TO RELATED APPLICATIONS

This application claims the benefit of U.S. Provisional Application No. 61/121,389 filed on Dec. 10, 2008, entitled “MAGNETO-OPTIC OPTICAL MODULATOR, which is incorporated herein in its entirety.

### TECHNICAL FIELD

The present invention relates generally to modulation, and more particularly to a magneto-optic optical modulator.

### BACKGROUND

Telecommunications systems, cable television systems and data communication networks use optical networks to rapidly convey large amounts of information between remote points. In an optical network, information is conveyed in the form of optical signals through optical fibers. Optical fibers comprise thin strands of glass capable of transmitting the signals over long distances with very low loss.

Many electronics components depend at least in part on electric input for their operation. For example, capacitors, transistors, diodes, etc. are driven by the application of voltage and/or current. In contrast, few devices are driven by magnetic input. Some examples include induction coils and transformers. Some optical components used in optical networks depend at least in part on the application of an electromagnetic field and/or temperature for their operation. For example, many optical devices depend on a changing refractive index in response to an electric field and/or temperature. To date, the operation of optical devices based on the application of a magnetic field has been limited.

Optical networks often employ wavelength division multiplexing (WDM) or dense wavelength division multiplexing (DWDM) to increase transmission capacity. In WDM and DWDM networks, a number of optical channels are carried in each fiber at disparate wavelengths. Network capacity is based on the number of wavelengths, or channels, in each fiber and the bandwidth, or size of the channels. Multiplexing can be used to increase the data rate in comparison to single stream transmission or to maintain the data rate but reduce the bandwidth requirements. Polarization modulation provides a shift in polarization which can be used to multiplex two or more data streams.

### SUMMARY

In accordance with a particular embodiment of the present invention, a device for modulating an optical beam is provided. The device may include a substrate comprising a non-ferromagnetic material, a thin film comprising a ferromagnetic semiconductor material disposed on the substrate, an inducer, and an electrical input. The thin film may be disposed on the substrate such that at least part of an optical beam incident on the thin film at an angle reflects off of a surface of the thin film. The thin film may be responsive to a magnetic field applied to the thin film such that varying the magnetic field varies the polarization of the light beam reflected off of the surface of the thin film. The inducer may be configured to vary the magnetic field applied to the thin film between at least two values for the magnetic field. The electrical input to the inducer may represent a data stream with at least two discrete values.

In accordance with another particular embodiment of the present invention, a multiplexing system for use with an optical communications network is provided. The system may comprise a transponder configured to emit a first optical beam, a modulator, an inducer, and a combiner. The polarization and/or amplitude modulator may include a substrate and a thin film. The substrate may include a non-ferromagnetic material. The thin film may include a ferromagnetic semiconductor material disposed on the substrate. The thin film may be disposed on the substrate such that at least part of the first optical beam incident on the thin film at an angle reflects off of a surface of the thin film. The thin film may be responsive to a magnetic field applied to the thin film such that varying the magnetic field varies the polarization of the first optical beam reflecting of off the surface of the thin film. The inducer may be configured to vary the magnetic field applied to the polarization modulator so that the polarization of the first optical beam propagating through the thin film is changed to a selected polarity. The combiner may be configured to superimpose the optical beam onto a second optical beam having a different polarity from the selected polarity of the first optical beam.

In accordance with another particular embodiment of the present invention, a method for modulating an optical beam is provided. The method may include providing a substrate and a ferromagnetic semiconductor material formed on the substrate. The method may include emitting an optical beam onto the ferromagnetic semiconductor material such that the optical beam reflects off of a surface of the ferromagnetic semiconductor material. The method may include applying a magnetic field to the ferromagnetic semiconductor material to vary the polarization of the light beam to a desired polarization amount while the optical beam is reflected from the surface of the ferromagnetic semiconductor material.

The ability to rotate the polarization of a beam of light may be useful in advanced modulation formats used for multiplexing of optical communication signals. For example, a dual polarization (DP) multiplexed optical beam may carry two discrete signals. Each of the two signals is carried by a light beam with a distinct polarization. Because the polarizations are distinct, the content of the two signals does not interfere and the two signals remain coherent. When the DP optical beam is received, the two discrete signals can be separated based on their polarization before each signal is processed.

An optoelectronic module configured to modulate polarity may reduce the part count and complexity of a polarization modulator in comparison to other modulators. A polarization modulator with reduced size may allow the configuration of an overall system to be more compact. An optoelectronic polarization modulator may require reduced power consumption in comparison to other modulators. The teachings of the present disclosure may be implemented using semiconductor processing and techniques which may be simple in comparison to other modulators (e.g., some polarization modulators include quantum wells). A polarization modulator fabricated with semiconductor technology may offer reduced response times in comparison to other polarization modulators.

It will be understood that the various embodiments of the present invention may include some, all, or none of the enumerated technical advantages. In addition, other technical advantages of the present invention may be readily apparent to one skilled in the art from the figures, description and claims included herein.

### BRIEF DESCRIPTION OF THE DRAWINGS

FIG. 1 illustrates a light beam incident upon a ferromagnetic semiconductor and the orientation of example magneto-optical effects in accordance with the teachings of the present disclosure;

FIG. 2 illustrates an example polarization modulator incorporating teachings of the present disclosure;

FIG. 3 shows example polarization modulator under the effect of a magnetic field applied to a thin film;

FIG. 4 illustrates an example dual polarization modulator incorporating teachings of the present disclosure; and

FIG. 5 illustrates an example system for encoding a data stream using polarization modulation.

### DETAILED DESCRIPTION

Optical computation systems may be implemented in optical networks to facilitate multiplexing and/or increased spectral efficiency (for example, networks implementing wavelength division multiplexing (WDM), dense wavelength division multiplexing (DWDM), or any other suitable multiplexing technique). In a multiplexed signal, there may be two or more discrete data streams superimposed into a single beam of light Implementation of the teachings of the present disclosure may provide increased density for multiplexed systems.

For example, in a dual polarization (DP) multiplexed system, there are two separate and distinct data streams superimposed into a single beam of light. Before they are combined, each data stream is first encoded onto a beam of light using a modulation scheme (e.g., quadrature phase shift keyed modulation (QPSK). The two beams have distinct polarizations (e.g., perpendicular to one another). Because of the distinct polarizations, multiplexing the two beams into a single beam does not lead to interference between the signals. The resulting beam can later be separated into two separate beams after it is received, based on the respective polarization states.

An optical computation system taking advantage of the teachings of the present disclosure may make use of polarization modulation to carry data signals in the polarization state itself. A polarization modulator configured to provide two or more discrete polarization states may be used to indicate a data value for each state. For example, a x-axis polarization may indicate a “0” and a y-axis polarization may indicate a “1”. The details of a scheme to map polarization states to data values may be designed to take advantage of the teachings of the present disclosure.

Known solutions for changing the polarization of a light beam may include passing the light beam through one or more optical devices (e.g., polarization beam splitter and combiner, and/or a half-wave plate). These solutions require free space optical components which may not be fabricated into an integrated circuit using semiconductor technology. In addition, use of beam splitters and combiners may require high levels of power consumption. In contrast, a polarization modulator fabricated with semiconductor technology may provide more compact solutions, simpler fabrication, reduced power load, and/or faster response time than free space optic components. In particular, the present disclosure describes how ferromagnetic semiconductors may be used to construct optical polarization modulators.

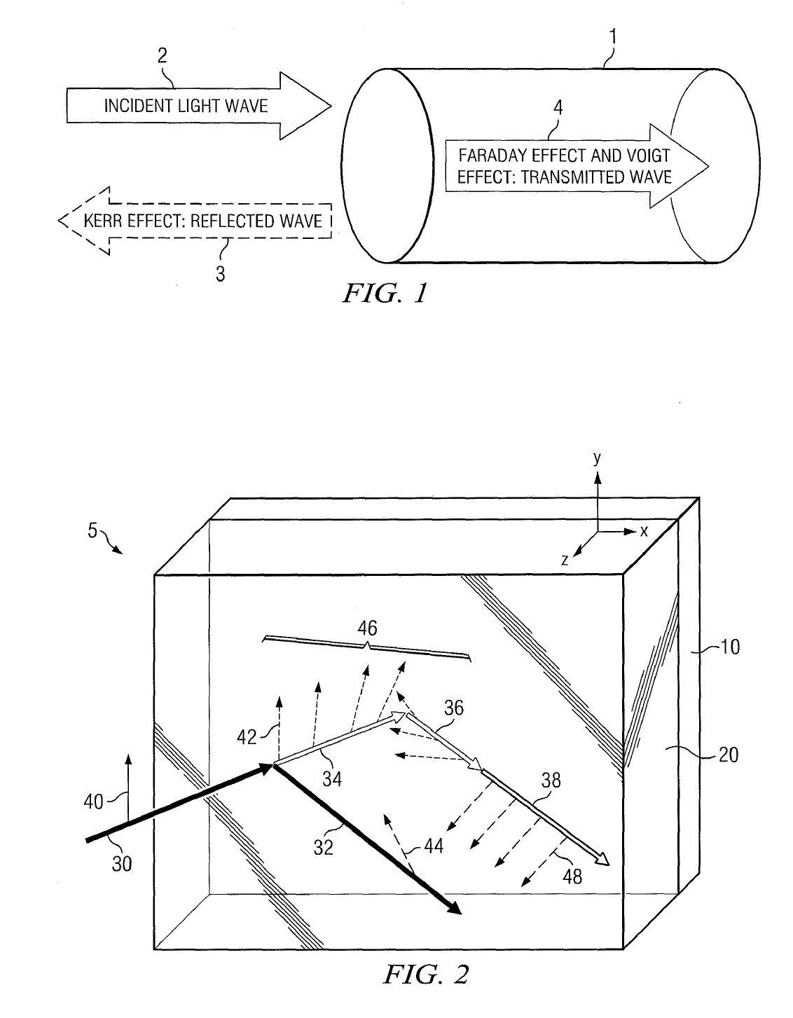

FIG. 1 illustrates a light beam 2 incident upon a ferromagnetic semiconductor 1 and the orientation of example magneto-optical effects 3 and 4 discussed herein. As shown in FIG. 1, light beam 2 incident on the surface of ferromagnetic semiconductor 1 may reflect from the surface and/or transmit through the material. In some cases, like the one shown in FIG. 1, a first portion of the light beam 2 reflects from the surface (at arrow 3) and a second portion transmits through the material (at arrow 4).

In one embodiment, a diluted (III,Mn)V semiconductor may change its material properties when placed in a magnetic field. Detailed reviews of how optical properties may be modified by magnetic field have been presented in (1) P. Strange, [Relativistic Quantum Mechanics], Cambridge University Press, Cambridge, pp. 497-505 (1998), and (2) V. Antonov, A. Yaresko, B. Harmon, [Electronic Structure and Magneto-Optical Properties of Solids], Kluwer Academic Publishers (2004). In particular, the polarization of a light beam reflecting from the surface of a diluted (III,Mn)V semiconductor may shift based on the application of a magnetic field to the semiconductor 1, because the magnetic permeability (μ) and components of dielectric tensor (εᵢⱼ) of a ferromagnetic semiconductor may vary based at least on the strength of an electromagnetic field applied to the material.

Three polarization effects based on the application of a magnetic field are shown in FIG. 1, illustrating that the Kerr effect occurs in a reflected beam 3 while the Faraday and Voigt effects occur in a transmitted beam 4. Rotation of the polarization of light beam 2 as it passes through the magnetooptic material is the result of either the Faraday effect (when the magnetic field is applied in the direction of light propagation) or the Voigt effect (when the magnetic field is applied perpendicular to the light propagation direction). The magneto-optic Kerr effect (MOKE) may be observed in reflected beam 3.

The Faraday effect, named after Michael Faraday, occurs in many optically transparent dielectric materials when strong magnetic fields are applied to the materials. The Faraday effect occurs because the speed of a light beam passing through the magnetized material depends on the polarization of the light beam. For example, in a ferromagnetic substance, the incident beam is decomposed into two circularly polarized beams which propagate at different speeds—also known as “circular birefringence.” When the two beams exit the substance, they re-combine. Because of the difference in propagation speed, however, there is an offset between the two components, which appears as a rotation of the angle of linear polarization of the resulting beam. The Voigt effect is usually used to describe this phenomenon when the substance is a vapor or a liquid. In either case, varying the strength of the applied magnetic field changes the amount by which the polarization of the transmitted beam is rotated.

FIG. 2 illustrates an example polarization modulator 5 incorporating teachings of the present disclosure. Polarization modulator 5 includes a substrate 10 and a thin film 20. FIG. 2 also shows a light beam 30 incident on the surface of thin film 20. A first portion 32 of light beam 30 reflects from the surface of thin film 20 (located at arrow 42). A second portion 34 of light beam 30 transmits through thin film 20. When second portion 34 of light beam 30 contacts substrate 10, second portion 34 of light beam 30 reflects and transmits through thin film 20 again (shown as third portion 36). Finally, third portion 36 exits thin film 20 and becomes fourth portion 38 of light beam 30. At the same time, a reflected portion 32 of light beam 30 reflects from the first surface of thin film 20 without passing through thin film 20.

Substrate 10 may be any appropriate non-ferromagnetic material. The appropriate selection of substrate 10 depends on the particular selection of a ferromagnetic semiconductor (e.g., based at least in part on the matching of lattice constants between the materials selected for thin film 20 and substrate 10). For example, silicon and/or gallium arsenide (GaAs) may provide an appropriate substrate for deposition of thin film 20. Silicon and gallium arsenide are used to make many semiconductor devices (e.g., infrared light emitting diodes (LED), laser diodes, solar cells, and/or microwave frequency integrated circuits).

Thin film 20 may include any appropriate ferromagnetic semiconductor. For example, use of a diluted (III,Mn)V semiconductor may provide the ability to manipulate light using the various effects described above in relation to FIG. 1. Some ferromagnetic semiconductors are relatively transparent to light, allowing the use of the Faraday effect described above. The thickness of thin film 20 may affect the overall transparency. In some embodiments, the thickness of thin film 20 may be selected to be less than the length of the wavelength of light beam 30. In some embodiments, the thickness of thin film 20 may be selected to be several times less than the length of the wavelength of light beam 30.

In some embodiments, the thickness of thin film 20 may be selected to avoid reducing the transparency of thin film 20 below an acceptable level. For example, thin film 20 may have a thickness in the range of 50 nanometers if it passes through thin film 20 only once. As shown in FIG. 2, the portion of light beam 30 transmitted through thin film 20 must pass through the thickness of thin film 20 twice before it exits as light beam 38. In embodiments using reflection, thin film 20 may have a thickness in the range of 35 nanometers.

Thin film 20 may be deposited on substrate 10 for several reasons. Because the thickness of thin film 20 may be in the range of 35-50 nanometers, a free-standing film may not be suitable. If a free-standing film is not suitable, substrate 10 may be included for structural support. As another example, the optical properties of thin film 20 and substrate 10 may include a high relative index contrast because thin film 20 is ferromagnetic and substrate 10 is not.

In an example embodiment, substrate 10 may include a combination of materials. For example, polarization modulator 5 may include thin film 20 including a 16 nm layer of InMnAs deposited on substrate 10 including 500 nm thick of AlSbAs, with a magnetization direction in plane with the surface of thin film 20. As another example, polarization modulator 5 may include thin film 20 including a 9 nm thick layer of InMnAs deposited on substrate 10 including 136 nm of AlSb, 400 nm of GaSb, and 300 nm of GaAs, with a magnetization direction perpendicular to the surface of thin film 20.

FIG. 2 also shows a representative polarization of each portion of light beam 30. For example, arrow 40 shows that light beam 30 has an upward vertical polarization (or positive y-polarization). At the first reflection point, arrow 42 shows that the light beam still has an upward vertical polarization. After it is reflected off of the surface of thin film 20, arrow 44 shows that first portion 32 of light beam 30 has a slightly rotated polarization. The rotation of the polarization shown in FIG. 2 is representative only and the actual amount of rotation depends on a large number of parameters (e.g., including εᵢⱼ and μ) including the MOKE effect.

At the same time, the portions of light beam 30 transmitting through thin film 20 may have a shifting polarization. For example, arrows 46 show that the polarization of second portion 34 and third portion 36 rotates as light beam 30 passes through thin film 20. In the example shown, arrows 48 show that the polarization of light beam 38 has shifted 90 degrees to a horizontal polarization (negative x-polarization) from the original polarization of light beam 30. The particular polarization shift shown is representative only. The teachings of the present disclosure may be applied to select any particular polarization shift desired by varying the thickness of thin film 20 or the selection of material of thin film 20. The particular polarization shift as light beam 34 passes through thin film 20 depends on the strength and orientation of the magnetic field as described more fully above related to the Faraday and/or the Voigt effects.

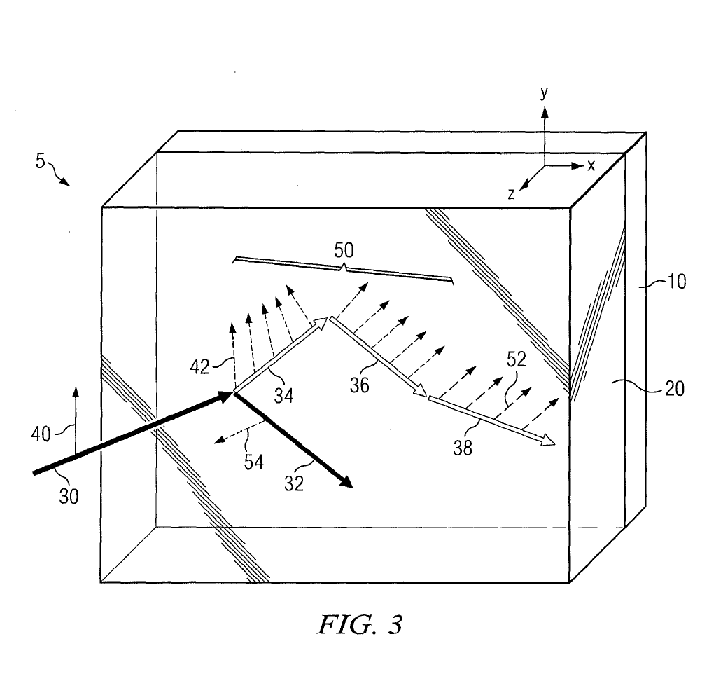

FIG. 3 shows example polarization modulator 5 under the effect of a different magnetic field applied to thin film 20. In FIG. 3, the effect on the polarization of light beam 30 is different from that shown in FIG. 2. Light beam 30 approaching polarization modulator 5 has a vertical polarization at arrows 40 and 42, as shown in FIG. 2. As second portion 34 and third portion 36 transmit through thin film 20, however, the polarization shift is in a different direction. When fourth portion 38 exits thin film 20, the polarization of light beam 30 is still a horizontal polarization, but it is in a different direction (positive x-polarization). At the same time, the reflected portion 32 of light beam 30 may have a greater change in polarization (shown by arrow 54) in comparison to the polarization of reflected portion 32 shown in FIG. 2.

Light beam 30 passing through thin film 20 of polarization modulator 5 and/or reflected from the first surface of thin film 20 will have a polarization dependent at least in part on the strength of the magnetic field applied to thin film 20 of polarization modulator 1. Changing the strength of the magnetic field changes the magnetic permeability of thin film 20. The corresponding change in permeability (μ) changes the rotation of the polarization of light beam 30. Use of the MOKE, Voigt, and/or Faraday effect may allow polarization modulator 5 to set the polarization of light beam 30 when it exits thin film 20.

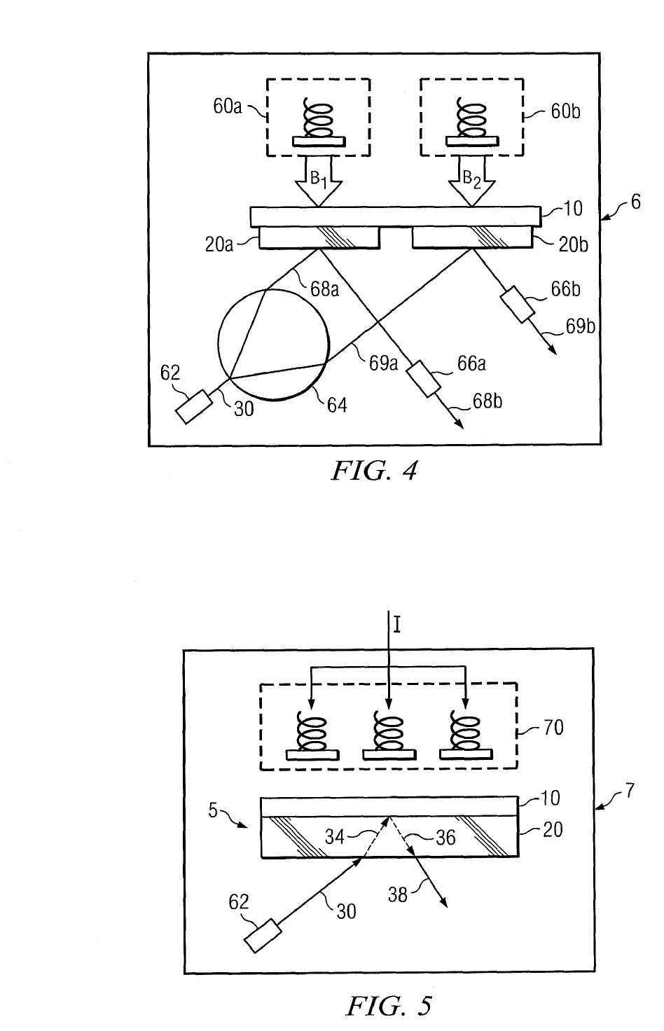

FIG. 4 illustrates an example dual polarization (DP) modulator 6 incorporating teachings of the present disclosure. DP modulator 6 may include a polarization modulator including two thin films 20a and 20b on a substrate 10, an inductor 60, a laser 62, a beam splitter 64, and two single polarization modulators 66a and 66b. Although FIG. 4 focuses on the use of light beam 30 reflected from the first surface of thin film 20 (e.g., using the Kerr effect), the teachings of the present disclosure may be incorporated by using a transmitted portion of light beam 30 (e.g., the Faraday effect) as more fully discussed in relation to FIGS. 1-3.

In the embodiment shown in FIG. 4, polarization modulator includes two thin films 20a and 20b. Each thin film (20a and 20b) may be driven by a respective inductor 60a and 60b. A polarization modulator including two thin films driven independently may allow two separate light beams (e.g., light beam 68a and 69a) to have independently modulated polarization states.

Inductor 60 may be any inductive component or device configured to apply a magnetic field to thin film 20. For example, inductor 60 may include a conducting wire shaped as a coil. When a current is passed through the coil, a strong magnetic field is created inside the coil. When activated, inductor 60 applies a magnetic field, shown by the vector, B, in FIG. 4. As described in relation to FIGS. 2 and 3, application of the magnetic field changes the polarization of the light beams incident on the surfaces of thin films 20a and 20b.

Laser 62 may include any component or device configured to emit a coherent light beam for use in an optical communication network. For example, laser 62 may include continuous wave beam lasers, amplitude modulators, and/or phase modulators. Beam splitter 64 may include any component or device configured to split light beam 30 into at least two portions (e.g., 68a and 69a). Because the polarization of each beam of light may be independently modulated by the application of separate magnetic fields by inductors 60a and 60b, a single beam of light launched by laser 62 may be separated into two beams of light 68a and 69a with, for example, perpendicularly polarized states.

Each beam of light 68a and 69a may pass through a respective modulator 66a and 66b. The output of the modulators may include two beams of light 68b and 69b with perpendicular polarization states, independently modulated for use in data transmission. For example, modulators 66a and 66b may include quadrature phase shift key (QPSK) or double phase shift key (DPSK) modulation.

In contrast to other techniques for producing a DP multiplexed beam of light, DP multiplexer 2 may eliminate the need for polarization beam splitters. Elimination of PBS components may reduce the power draw of a DP multiplexer. In addition, making an optical device smaller may provide additional reductions in power draw and/or increased port density. The embodiment described above may provide a multiplexed light beam for use in 40G/100G transmission.

FIG. 5 illustrates an example system 7 for encoding a data stream using polarization modulator 5 and an inductor 70. As described above, polarization modulator 5 may be operable to generate at least two polarization states based on the strength of a magnetic field applied by inductor 70: x-axis polarization and y-axis polarization. The electrical input, I, to polarization modulator 5 may include a digital data stream (e.g., discrete bits of either “0” or “1”). As an example, polarization modulator 5 may be configured to produce a x-axis polarization to represent a “0” bit and a y-axis polarization to represent a “1” bit. In contrast to a polarization multiplexed system carrying two separately polarized data streams, system 7 uses the polarization of the beam itself to indicate the value of the data stream. Although FIG. 5 focuses on the use of light beam 30 transmitted through thin film 20, the teachings of the present disclosure may be incorporated by using a reflected portion of light beam 30 as more fully discussed in relation to FIGS. 1-3.

Although the present invention has been described with several embodiments, various changes and modifications may be suggested to one skilled in the art. It is intended that the present invention encompass such changes and modifications as fall within the scope of the appended claims. For example, polarization modulator 5 described herein may be incorporated with amplitude and phase modulators to provide additional modulation schemes (e.g., dual polarization quadrature phase shift keyed modulation (DP-QPSK)).

What is claimed:

1. A device for modulating an optical beam, the device comprising:
a substrate comprising a non-ferromagnetic material; and
a thin film comprising a ferromagnetic semiconductor material disposed on the substrate;
the thin film disposed on the substrate such that at least part of an optical beam incident on the thin film at an angle reflects from a surface of the thin film;
the thin film responsive to a magnetic field applied to the thin film such that varying the magnetic field varies the polarization of the light beam reflected off of the surface of the thin film;
an inducer configured to vary the magnetic field applied to the thin film between at least two values for the magnetic field; and
electrical input to the inducer, the electrical input representing a data stream with at least two discrete values.

2. A device according to claim 1, further comprising a continuous wave laser disposed to produce the optical beam incident on the thin film.

3. A device according to claim 1, further comprising an amplitude modulator disposed to produce the optical beam incident on the thin film.

4. A device according to claim 1, further comprising a phase modulator disposed to produce the optical beam incident on the thin film.

5. A device according to claim 1, wherein the ferromagnetic semiconductor comprises a diluted (III,Mn)V semiconductor.

6. A device according to claim 1, wherein the ferromagnetic semiconductor comprises InMnAs.

7. A multiplexing system for use with an optical communications network, the system comprising:
a laser configured to emit an optical beam;
a substrate comprising a non-ferromagnetic material; and
two thin films disposed on the substrate, each thin film comprising a ferromagnetic semiconductor material;
the two thin films responsive to an applied magnetic field such that varying the magnetic field varies the polarization of a portion of the optical beam reflecting from the surface of each of the two thin films; and
two inducers disposed to independently drive the two thin films, such that the polarity of the portion of the optical beam reflecting from the surface of each of the two films may be independently selected;
a beam splitter disposed to split the optical beam into a first portion and a second portion and to emit the first portion of the optical beam onto one of the two thin films and to emit the second portion of the optical beam onto the other thin film such that the first portion and the second portion reflect from a surface of the two thin films; and
two modulators disposed to receive the first portion and the second portion after they have been reflected from the two thin films;
wherein the first portion and the second portion of the optical beam are independently modulated by the two modulators.

8. A system according to claim 7, wherein the two inducers comprise coils configured to vary the magnetic field applied to the two thin films.

9. A system according to claim 7, wherein the laser comprises a continuous wave laser disposed to produce the optical beam.

10. A system according to claim 7, wherein the two modulators include amplitude modulators.

11. A system according to claim 7, wherein the two modulators include phase modulators.

12. A system according to claim 7, wherein the selected polarity of the first portion of the optical beam and selected polarity of the second portion of the optical beam are perpendicular to one another.

13. A system according to claim 7, wherein the ferromagnetic semiconductor comprises a diluted (III,Mn)V semiconductor.

14. A system according to claim 7, wherein the ferromagnetic semiconductor comprises InMnAs.

15. A system for encoding data in the polarization of an optical beam, the system comprising:
a laser configured to emit an optical beam;
a substrate comprising a non-ferromagnetic material; and
a thin film comprising a ferromagnetic semiconductor material disposed on the substrate;
the thin film disposed on the substrate such that at least part of an optical beam incident on the thin film reflects off of a surface of the thin film;
the thin film responsive to a magnetic field applied to the thin film such that varying the magnetic field varies the polarization of the light beam reflected off of the surface of the thin film;
a coil configured to vary the magnetic field applied to the thin film between at least two values for the magnetic field; and
electrical input to the coil, the electrical input representing a data stream with at least two discrete values;
wherein the at least two discrete values of the electrical input to the coil correspond to the at least two values for the magnetic field, resulting in at least two discrete polarization states for the light beam reflected off of the surface of the thin film.

16. A system according to claim 15, wherein the laser is a continuous wave laser.

17. A system according to claim 15, wherein the ferromagnetic semiconductor comprises a diluted (III,Mn)V semiconductor.

18. A system according to claim 15, further comprising a phase modulator disposed to produce the optical beam incident on the thin film.

19. A system according to claim 15, further comprising an amplitude modulator disposed to produce the optical beam incident on the thin film.

20. A system according to claim 15, wherein the ferromagnetic semiconductor comprises InMnAs.
